(19) United States
(12) Patent Application Publication
(10) Pub. No.: US 2015/0156416 A1
(43) Pub. Date: Jun. 4, 2015

(54) Systems and Methods for Updating Panoramic Images

(71) Applicant: Google Inc., (US)

(72) Inventor: Daniel Joseph Filip, San Jose, CA (US)

(73) Assignee: Google Inc., Mountain View, CA (US)

(21) Appl. No.: 13/858,514

(22) Filed: Apr. 8, 2013

Related U.S. Application Data
(60) Provisional application No. 61/784,464, filed on Mar. 14, 2013.

(51) Int. Cl. H04N 5/232

(52) U.S. Cl. CPC H04N 5/23238

(57) ABSTRACT

Embodiments include a computer-implemented method that includes receiving, from a mobile user device configured to acquire images, a request to update a panoramic image, identifying a location associated with a panoramic image, guiding a user to the location associated with the panoramic image, receiving, from the mobile user device, an image acquired at or near the location associated with the panoramic image, updating the panoramic image to include the image acquired at or near the location associated with the panoramic image to generate an updated panoramic image, and storing the updated panoramic image in association with the location.

### RELATED APPLICATIONS

This application claims the benefit of U.S. Provisional Patent Application No. 61/784,464 filed on Mar. 14, 2013, entitled “SYSTEMS AND METHODS FOR UPDATING PANORAMIC IMAGES”, the entirety of which is hereby incorporated by reference.

### BACKGROUND OF THE INVENTION

1. Field of the Invention

Embodiments of this invention relate generally to panoramic images and, more particularly, to updating panoramic images.

2. Description of the Related Art

Panoramic photography involves capturing images with enlarged fields of view. A panoramic image may include, for example, a wide field of view having an aspect ratio of 2:1 or greater (i.e., the image being at least twice as wide as it is high). A panoramic image may have, for example, a field of view that is approximately the same, or greater than the approximate viewing angle of the human eye (i.e., the same or greater than about, 106-degrees by 75-degrees). In some instances, a panoramic image may include a complete field of view about a location. For example, a full panoramic image may include a 360-degree field of view that captures what a person would see if they turned in a complete circle while standing at a location. In some instances, panoramic images can be used by mapping applications to allow a user to “step-into” a map to view a panoramic view of a location. For example, using Google Street View™ mapping service a user can explore places around the world through 360-degree street-level imagery or similar imagery.

Panoramic images can be captured using cameras that have a wide angle lens to acquire a wide field of view, or by capturing multiple images across a field of view that can be combined (e.g., stitched together) to generate a panoramic image. In some instances, a digital camera may be equipped with video capture capabilities to continuously capture images as the camera rotates through a field of view about a location. The resulting images can, then, be stitched together to construct a panoramic image of the location.

Occasionally, it may be desirable to update a panoramic image with a completely new panoramic image, or update just a portion of panoramic image. Unfortunately, to update a panoramic image, a new image may need to be acquired from substantially the same position as the original panoramic image to acquire the same or similar field of view. Acquiring of images from substantially the same position as the original panoramic image can be tedious and time-consuming. As a result, the images acquired for use in updating panoramic images are often of low quality and, thus, cannot be used in updating a panoramic image. Moreover, if images used to generate or update a panoramic image are not acquired from substantially the same position, the spacing between different panoramic images (e.g., street-level images) may be inconsistent, diminishing the user's navigational experience when viewing panoramic images at different locations. For example, inconsistent distances between images may result in a choppy navigation using the street-level imagery, as opposed to a consistent/smooth navigation view, as the user request to move from one location to another within a map to view the panoramic images at the corresponding locations.

### SUMMARY OF THE INVENTION

Various embodiments of methods and apparatus for updating panoramic images are provided. In some embodiments, provided is a computer-implemented method that includes receiving, from a mobile user device configured to acquire images, a request to update a panoramic image, identifying a location associated with a panoramic image, guiding a user to the location associated with the panoramic image, receiving, from the mobile user device, an image acquired at or near the location associated with the panoramic image, updating the panoramic image to include the image acquired at or near the location associated with the panoramic image to generate an updated panoramic image, and storing the updated panoramic image in association with the location

In some embodiments, provided is a system including one or more memories storing instructions and one or more processors coupled to the one or more memories and configured to execute the instructions stored thereon to cause the following steps: receiving, from a mobile user device configured to acquire images, a request to update a panoramic image, identifying a location associated with a panoramic image, guiding a user to the location associated with the panoramic image, receiving, from the mobile user device, an image acquired at or near the location associated with the panoramic image, updating the panoramic image to include the image acquired at or near the location associated with the panoramic image to generate an updated panoramic image, and storing the updated panoramic image in association with the location.

In some embodiments, provided is a non-transitory computer readable medium comprising program instructions stored thereon that are executable by a processor to cause the following steps: receiving, from a mobile user device configured to acquire images, a request to update a panoramic image, identifying a location associated with a panoramic image, guiding a user to the location associated with the panoramic image, receiving, from the mobile user device, an image acquired at or near the location associated with the panoramic image, updating the panoramic image to include the image acquired at or near the location associated with the panoramic image to generate an updated panoramic image, and storing the updated panoramic image in association with the location.

### BRIEF DESCRIPTION OF THE DRAWINGS

FIG. 1 illustrates an exemplary panoramic image in accordance with one or more embodiments of the present technique.

FIG. 2 is a diagram that illustrates a top-view of a location and a corresponding panoramic image field of view in accordance with one or more embodiments of the present technique.

FIG. 3 is a flowchart that illustrates a method of acquiring panoramic images in accordance with one or more embodiments of the present technique.

FIG. 4 is a diagram that illustrates locations of multiple panoramic images in accordance with one or more embodiments of the present technique.

FIGS. 5A and 5B illustrate exemplary updated panoramic images in accordance with one or more embodiments of the present technique.

FIG. 6 is a block diagram that illustrates an image acquisition environment in accordance with one or more embodiments of the present technique.

FIG. 7 is a block diagram that illustrates an exemplary computer system in accordance with one or more embodiments of the present technique.

### DETAILED DESCRIPTION

As discussed in more detail below, provided are systems and methods for updating panoramic images. Panoramic images include images with enlarged fields of view. A panoramic image may include, for example, a wide field of view having an aspect ratio of 2:1 or greater (i.e., the image being at least twice as wide as it is high). Panoramic images may include, but are not limited to, full panoramic images having a 360-degree field of view, such as panoramic images used for 360-degree street-level imagery or similar imagery. In some embodiments, instructions are provided to assist users with the acquisition of images used for updating panoramic images. For example, where a user desires to update an existing panoramic image, a location associated with the panoramic image can be determined, and instructions can be provided to guide the user to the location and to assist them with capturing, or acquiring, the images. The acquired images can, then, be used to update the panoramic image associated with the location. For example, where a panoramic image exists for the location and the user acquires a complete set of images that can be used to generate a full panoramic image for the location (e.g., a 360-degree field of view of the location that depicts what a person would see if they turned in a complete circle while standing at the location), the set of images can be combined (e.g., stitched together) to generate a full panoramic image for the location. The full panoramic image can replace the existing panoramic image for the location. That is, the update may include completely replacing the old panoramic image for the location with the new, or “updated”, full panoramic image. Where a panoramic image exists for a location and the user acquires a set of images that can be used to generate a portion of the panoramic image for the location (e.g., a 110-degree field of view of the location), the set of images can be combined with the existing panoramic image for the location (e.g., stitched into the existing panoramic image) to generate an updated panoramic image for the location. That is, the update may include replacing a portion of the old panoramic image for the location with the new, or “updated”, images for that particular portion of the panoramic image. Such an embodiment may allow a portion of the panoramic image to be update where, for example, only that portion of the field of view has changed substantially since the existing panoramic image was captured.

In some embodiments, instructions are provided to help the user navigate to the location associated with the panoramic image and/or to help the user properly position their camera to capture images for use in updating the panoramic image. For example, upon determining that the user is currently located approximately ten meters east of the location associated with the panoramic image to be updated, the instructions may instruct the user to move ten meters to the west. When the user is determined to be at or near the location, the instructions may instruct the user to aim their camera in a direction consistent with the location of the images to be acquired. For example, once it is determined that the user is at or near the location and the user currently has the camera is aimed too low, the instructions may instruct the user to tilt the camera upward such that it is aimed higher to align with the field of view of the existing panoramic image to be updated. The instructions may also provide guidance for capturing the images. For example, once it is determined that the camera is properly positioned to capture the images needed to update the panoramic image, the instructions may instruct the user to move (e.g., rotate) the camera in a given direction (e.g., clockwise) to pan across some or all of the field of view of the panoramic image to be updated. As the images are being acquired, the image acquisition process may be continually monitored, and real-time feedback may be provided to the user to assist with the image capture. For example, if the user moves from the location during the image capture, instructions may be provide that instruct the user to return to the location and/or if the aim of the camera begins to drift from the field of view of the panoramic image to be updated, instructions may be provide that instruct the user to adjust the aim of the camera to coincide/align with the field of view of the panoramic image to be updated.

Although certain embodiments are described with regard to updating existing panoramic images, similar embodiments can be used to acquire new panoramic images for locations that do not have existing panoramic images associated therewith. For example, where a user request to update a panoramic image while at a given location, and it is determined that a panoramic image does not exist at or near the given location, a location for a panoramic image at or near the given location may be determined, instructions may be provided to guide the user to the location and/or to assist in capturing the set of images needed to generate a full or partial panoramic image for the location, the images may be acquired, and the images may be used to generate a full or partial panoramic image for the location. In such an embodiment, the update may include associating the new, or “updated”, panoramic image, with the location.

Such guided/assisted capture of panoramic images may be well suited for aiding users with the capture of images that can be used to update a database of panoramic images. For example, where a map provider, such as Google Street View™ mapping service, includes panoramic images of hundreds of thousands of places around the world, these panoramic images can be updated using images captured by users. For example, if a user notices that a new business has opened in the location of an old business, and a sign for the business has changed to reflect the name of the new business, the user can submit a request to update the panoramic image when standing near the store, a nearby location associated with an existing panoramic image can be determined, instructions can be provided to the user to guide them to the location and/or to assist them in re-capturing some or all of the existing panoramic image, and the new/updated set of images captured by the user can be used to update the existing panoramic image. When a user subsequently request to view street-level imagery of the location, the user may be provided with the updated panoramic image depicting the sign with the new name as opposed to the outdated panoramic image that included the sign for the previous business. Such a process can be repeated by users around the world in an effort to keep a database of panoramic images up-to-date.

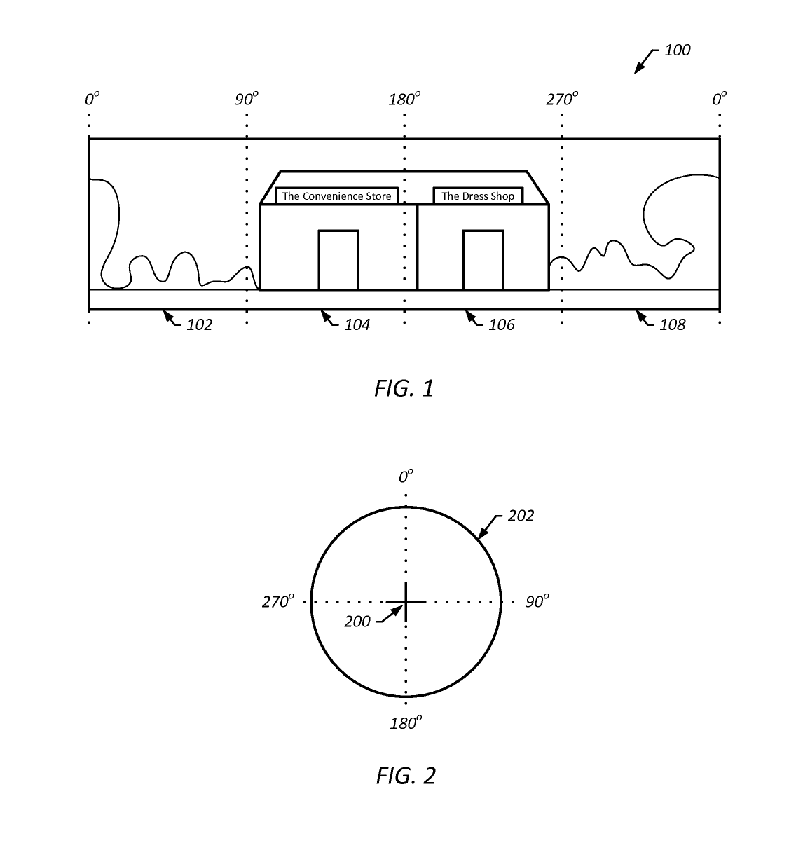

FIG. 1 illustrates an exemplary panoramic image (“pano”) 100 in accordance with one or more embodiments of the present technique. In the illustrated embodiment, panoramic image 100 is a full panoramic image that includes a 360-degree field of view at a location (e.g., location 200 of FIG. 2) that captures what a person would see if they turned in a complete circle while standing at the location. FIG. 2 is a diagram that illustrates a top-view (i.e., looking down from above) of location 200 and a corresponding panoramic image field of view (“FOV”) 202 in accordance with one or more embodiments of the present technique. Location 200 includes a particular geographic point, and field of view 302 represents a corresponding full 360-degree FOV about the point. The vertical degree markers of 0°, 90°, 180° and 270° of panoramic image 100 correspond to respective directional markers 0°, 90°, 180° and 270° of FOV 202.

In the illustrated embodiment, panoramic image 100 has an aspect ratio of about 4:1 That is, the width of panoramic image 100 is about four times its height. A first portion of panoramic image 100, between the vertical lines at 0° and 90°, depicts what a user would see while standing at location 200 and looking in the direction of 45° of FOV 202, a second portion of panoramic image 100, between the vertical lines at 90° and 180°, depicts what a user would see while standing at location 200 and looking in the direction of 135° of FOV 202, and so forth. Each of the sub-portions of the field of view of a panoramic image may be referred to as a “sub-pano”. For example, panoramic image 100 may include first, second, third and fourth sub-panos 102, 104, 106 and 108, respectively.

In some embodiments, a panoramic image is constructed using one or more individual images. For example, where a camera having a field of view of about 110° is used to capture images for constructing panoramic image 100, as few as four separate images can be used to generate the entirety of panoramic image 100. Panoramic image 100 may be constructed, for example, using a first image taken with the camera aimed at about 45° of FOV 202 and capturing a field of view spanning from about −10° (or 350°) to about 100° of FOV 202, a second image taken with the camera aimed at about 135° of FOV 202 and capturing a field of view spanning from about 80° to about 190° of FOV 202, a third image taken with the camera aimed at about 225° of FOV 202 and capturing a field of view spanning from about 170° to about 280° of FOV 202, and a fourth image taken with the camera aimed at about 315° of FOV 202 and capturing a field of view spanning from about 260° to about 10° of FOV 202. In such an embodiment, sub-panos 102, 104, 106 and 108 of panoramic image 100 may correspond to the first, second, third and fourth images, respectively. Panoramic image 100 may be constructed by stitching together of the individual images. Stitching may include the processing registering (e.g., matching features in overlapping portions of the multiple images), calibrating (e.g., aligning and scaling the images to account for distortions, exposure differences, and the like), and blending (e.g., executing the calibration to combine/merge the multiple individual images into a single image).

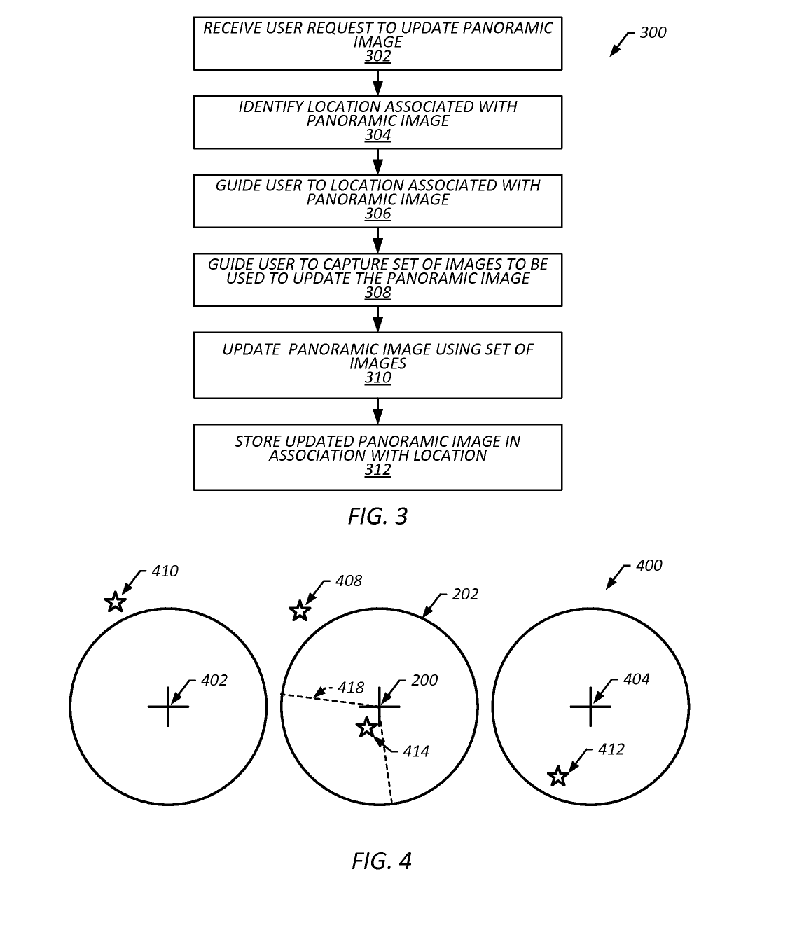

FIG. 3 is a flowchart that illustrates a method 300 of updating a panoramic image in accordance with one or more embodiments of the present technique. Method 300 may generally include receiving a user request to update a panoramic image, identifying a location associated with the panoramic image, guiding the user to the location associated with the panoramic image, guiding the user to capture a set of images to be used to update the panoramic image, updating the panoramic image using the set of images, and storing the updated panoramic image in association with the location.

Method 300 may include receiving a user request to update a panoramic image (block 302). In some embodiments, receiving a user request to update a panoramic image includes a user providing an indication that they desire to capture at least a portion of a panoramic image using a mobile device. For example, when located near location 200, a user may notice that “The Dress Shop” has recently changed names to “Clothing Depot”, and the sign on the exterior of the business has changed to reflect the new name. Knowing that panoramic images for the area do not depict the new sign for “Clothing Depot”, the user may open a panoramic image acquisition application of their camera phone and use the application to submit a request to update a panoramic image. Such a request may be received, for example, by a panoramic image processing module of a server.

Method 300 may include identifying a location associated with the panoramic image (block 304). In some embodiments, identifying a location associated with the panoramic image includes identifying a current location of the user and determining a geographic location (“geolocation”) associated with a panoramic image (a “panoramic image location”) that is proximate the current location of the user. For example, referring now to FIG. 4, if a panoramic image exists for each of geolocation 200 and it is determined that the user is currently at geolocation 408, geolocation 200 may be identified as the panoramic image location. In some embodiments, identifying a location associated with the panoramic image includes identifying the panoramic image location nearest the user. For example, if a panoramic image exists for each of geolocations 200, 402 and 404, and it is determined that the user is currently at geolocation 408, 410 or 412, respective geolocations 200, 402 or 404 may be identified as the panoramic image location. Thus, a panoramic image location nearest the user may be identified as the location associated with the panoramic image.

In some embodiments, identifying a location associated with the panoramic image includes receiving a user selection of a panoramic image location. For example, where it is determined that the user is currently located at geolocation 408, and panoramic image locations 200, 402 and 404 are identified as being near location 408 (e.g., within a threshold distance, such as 100 m), the user may be presented with an option to select one of the three locations 200, 402 and 404. The panoramic image location selected by the user may be identified as the panoramic image location.

In some embodiments, a current location of the user is determined based on the location of the user's mobile device. For example, where the user submits the request to update a panoramic image from their camera phone, and the phone includes an integrated GPS (Global Positioning System) device that is capable of determining the geolocation of the phone, a geolocation provided by the GPS device may be used as the current location of the user. Embodiments may employ any suitable techniques for determining a position of a mobile device. A user may be provided with the option to share their location information. For example, a user may be provided with information that describes what data is to be collected and how it is used, and may have the option to consent to sharing their location information. If the user does not consent, such information will not be collected or used. If the user does consent to collection and/or use of the data, they have the option to revoke or modify their consent at anytime (e.g., through a dashboard interface or other interface).

Method 300 may include guiding the user to the location associated with the panoramic image. In some embodiments, guiding the user to the location associated with the panoramic image includes providing instructions to help the user navigate from their current location to the location associated with the panoramic image. For example, if it is determined that the user is located at geolocation 408, geolocation 200 is identified as the location associated with the panoramic image, and geolocation 408 is about fifty meters to the northwest of geolocation 200, the instructions may instruct the user to move approximately fifty meters to the southeast. The instructions may include audible, written or graphical instructions. For example, a spoken instruction stating “please move approximately fifty meters to the southeast” may be announced via speaker of the user's phone, a written instruction stating “Please move approximately fifty meters to the southeast” may be displayed via graphical user interface (e.g., a screen) of the user's phone, and/or a graphical illustration, such as an arrow icon, pointing toward a relative location geolocation 200 may be displayed via graphical user interface of the user's phone. In some embodiments, instructions are updated dynamically as the user navigates to the location associated with the panoramic image and/or repositions the camera. For example, if the user moves to geolocation 414, approximately ten meters to the southwest of geolocation 200, an updated set of instructions may be provided that instruct the user to move approximately ten meters northeast of their current location.

In some embodiments, a positive indication is provided when the user is at or near the location associated with the panoramic image. For example, if it is determined that the user is at or near the location associated with the panoramic image, a vocal prompt stating “you are at the correct location” may be announced or a sound (e.g., a beep) may be played via speaker of the user's phone, a written instruction stating “You are at the correct location” may be displayed via graphical user interface of the user's phone, and/or a graphical illustration, such as a check icon, may be displayed via graphical user interface of the user's phone. If the user moves away from the location, the positive indication may be removed and/or additional instructions may be provided to help the user navigate back to the location associated with the panoramic image.

Method 300 may include guiding the user to capture a set of images to be used to updating the panoramic image (block 308). In some embodiments, guiding the user to capture images to be used to update the panoramic image includes providing instructions to help the user position, or aim, the camera for capturing of the images and/or to help the user to remain in the location associated with the panoramic image. For example, if it is determined that the user is at or near the location associated with the panoramic image, a set of instructions may be provided to instruct the user to aim a camera of their mobile device in a direction consistent with the location of the images to be acquired. An instruction may, for example, instruct the user to hold the camera level and aim the camera in a substantially horizontal direction. The instructions may include audible, written or graphical instructions. For example, a vocal instruction stating “please aim the camera in a horizontal direction” may be announced via speaker of the user's phone, a written instruction stating “Please aim the camera in a horizontal direction” may be displayed via graphical user interface of the user's phone, and/or a graphical illustration, such as an arrow icon, pointing in a direction where the camera should be aimed may be displayed via graphical user interface of the user's phone.

In some embodiments, guiding the user to capture images to be used to update the panoramic image includes providing instructions to the user to assist in capturing images once the camera is positioned/aimed correctly. The instruction may state, for example, “Your camera is properly aligned—Please begin you image capture and rotate your camera clockwise while keeping the camera level.” The user may, then, sweep the camera through the FOV 202 by turning in circle while standing at location 200 and keeping the camera aimed at substantially the same vertical orientation (i.e., keeping the camera level). The set of one or more images acquired may, then, be used to update the panoramic image for the location.

In some embodiments, the position of the camera is determined based on an integrated positioning device, such as a gyroscope. For example, if the user's mobile camera phone includes a gyroscope, the orientation of the camera phone can be determined based on orientation data output by the gyroscope. In some embodiments, the position of the camera is determined based on a comparison of images captured by the camera to portions of the existing panoramic image for the location. For example, the field of view of an image that is acquired by the camera may be compared to the field of view of the existing panoramic image for the location to determine whether or not at least a portion of the currently acquired image matches at least a portion of the panoramic image associated with the location. Matching of features/portions of images can be provided by any suitable image matching technique, such as SIFT (Scale-invariant feature transform) feature matching. In some embodiments, the position of the camera is determined based on a full or partial match of at least a portion of the acquired image to at least a portion of the panoramic image. For example, if the acquired image depicts a scene that matches sub-pano 106 of FIG. 1 (i.e., is determined to be the same or similar to sub-pano 106 of FIG. 1), it may be determined that the camera is aimed at 225° of field of view 202 (as depicted by dashed lines 418) and is substantially level based on a match between the image and a portion of the panoramic image. As a further example, if the acquired image depicts a scene having a top-half of the image that matches a lower half of the scene depicted in sub-pano 106 of FIG. 1 (i.e., is the same or similar to a lower half of the scene depicted in sub-pano 106 of FIG. 1), it may be determined that the camera is aimed at 225° of field of view 202 (as depicted by dashed lines 418) and aimed downward by 30° (i.e., tilted downward 30°) based on the top half of the acquired image matching lower half of pano 106. Similar determinations of the position of the camera can be made based on the relative locations of matches between portions of acquired images and portions of the existing panoramic image for the location.

In some embodiments, updated instructions are continually provided to help the user maintain the camera in a suitable position for acquiring images. For example, if it is determined that the user has moved slightly to the left from the location associated with the panoramic image and the camera is tilted too far upward, a set of instruction may be presented that instruct the user move slight to the right and tilt the camera downward into a level position. Such dynamic instructions may help the user navigate to and remain in the location associated with the panoramic image and/or help the user to keep the camera aimed in a direction that is coincident with the field of view of the panoramic image before and during an image capture process.

In some embodiments, the guided capture may provide for capture of multiple images. For example, where at least four images are required to generate a full panoramic image of a location, the instruction may, instruct the user to aim the camera to about 315° of FOV 202 and capture a first image, then aim the camera to about 45° of FOV 202 and capture a second image, then aim the camera to about 135° of FOV 202 and capture a third image, and then aim the camera to about 225° of FOV 202 and capture a fourth image, resulting in a set of four images that can be used to generate a full panoramic image for the location. In some embodiments, the image capture may include a video type capture that repeatedly/continuously captures images as the user sweeps aim of the camera though the field of view. For example, where an image is captured every 0.25 seconds, and the user sweeps the camera through FOV 202 in five seconds, the acquisition may result in a set of twenty images. In some embodiments, the image capture may include capture of only a single image. For example, where a new sign for “Clothing Depot” has replaced a sign for “The Dress Shop”, and the user desires to update only the portion of the panoramic image 100 that includes the signs, the user may simply aim the camera to about 225° of FOV 202 and capture a single image having a field of view that is similar to that of sub-pano 106.

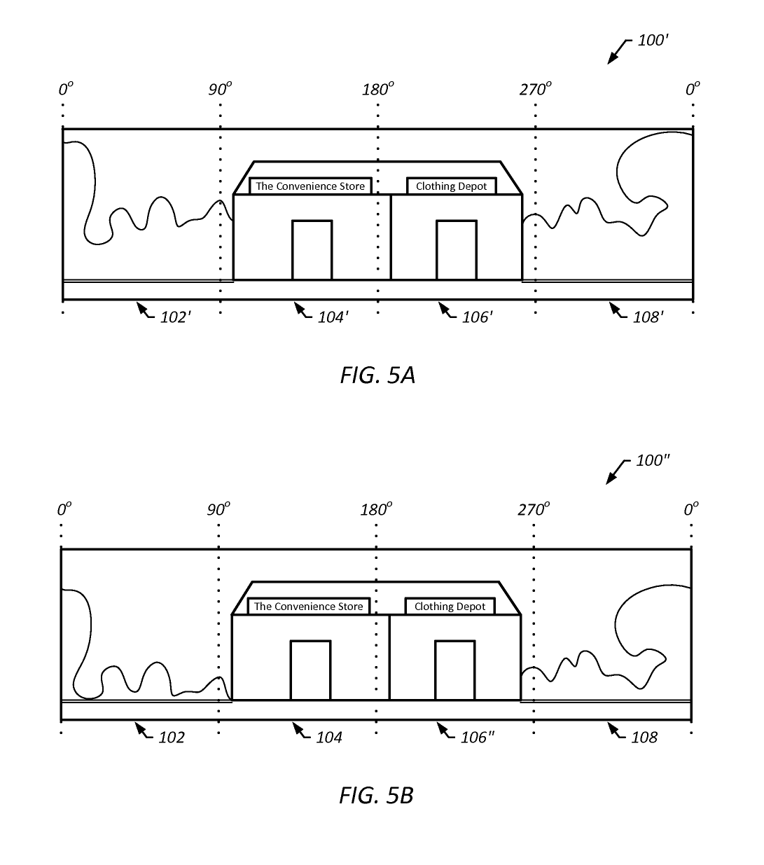

Method 300 may include updating the panoramic image using the set of acquired images (block 310). In some embodiments, updating the panoramic image includes updating the entirety of the panoramic image for the location. For example, where the set of images acquired at block 308 includes four images (e.g., first, second, third and fourth images taken with the camera aimed at about 45°, 135°, 225°, 315° of FOV 202, respectively), the four images may be stitched together to generate updated panoramic image 100′ of FIG. 5A. Image 100′ includes four sub-panos 102′, 104′, 106′ and 108′ that are each updated. That is, the set of images may be stitched together to generate an entirely new full panoramic image that can replace the entirety of the existing panoramic image.

In some embodiments, updating the panoramic image includes updating only a portion of the panoramic image for the location. For example, where the set of images acquired at block 308 includes only a single updated image (e.g., an image taken with the camera aimed at about 225° of FOV 202), the updated image may be stitched into a corresponding portion of existing panoramic image to generate the updated panoramic image 100″ of FIG. 5B. Image 100″ includes a single updated sub-pano 106″ (corresponding to the updated image) that is combined with the existing sub-panos 102, 104 and 108. That is, the set of images may be stitched into the existing panoramic image to replace only the corresponding portions of the existing panoramic image. Although the illustrated embodiment includes a single image being used to update a portion of the existing panoramic image, any number and combination of images can be used to update an existing panoramic image. For example, if the set of images includes images corresponding to sub-panos 102, 104 and 106, the portions of panoramic image 100 corresponding to sub-panos 102, 104 and 106 may be updated using the set of images, and the portion of panoramic image 100 corresponding to sub-pano 108 may remain substantially the same.

Method 300 may include storing the updated panoramic image in association with the location (block 314). In some embodiments, storing the updated panoramic image in association with the location includes storing the updated panoramic image in place of the existing panoramic image associated with the location. Thus, for example, upon a subsequent request for panoramic image associated with a location, the updated/current panoramic image may be provided, as opposed to the existing/outdated panoramic image associated with the location.

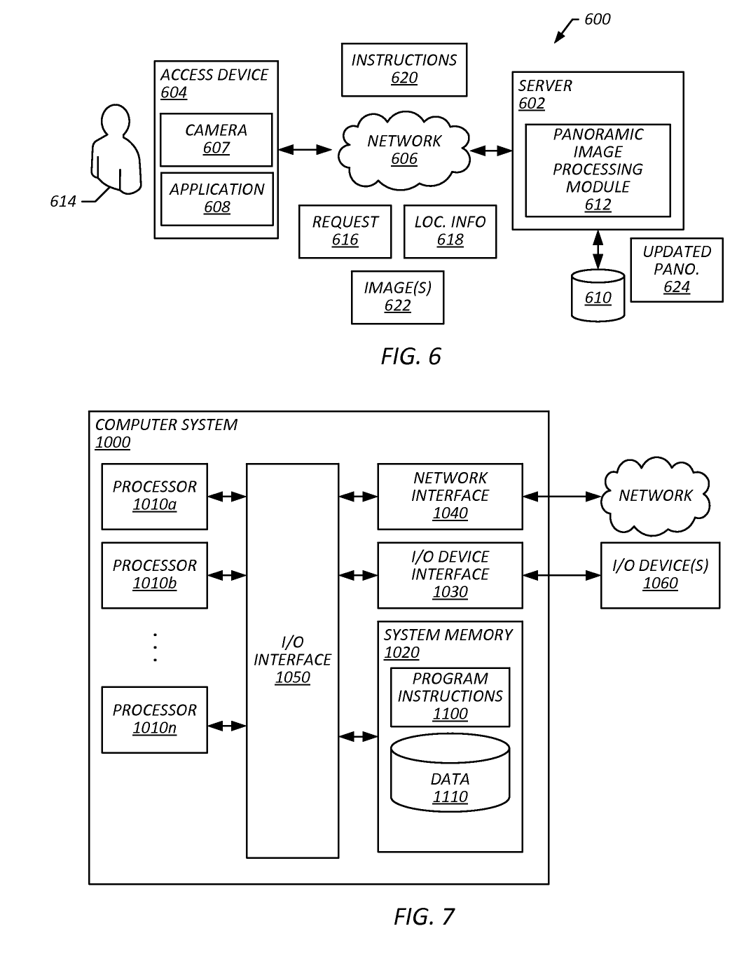

Method 300 is an exemplary embodiment of a method that may be employed in accordance with the techniques described herein. Method 300 may be modified to facilitate variations of its implementations and uses. Method 300 may be implemented in software, hardware, or a combination thereof. Some or all of method 300 may be implemented by one or more of the modules/applications described herein, such as panoramic image acquisition module 612 and/or application 608 depicted and described in more detail below with regard to FIG. 6. The order of the steps of method 300 may be changed, and various elements may be added, reordered, combined, omitted, modified, etc.

FIG. 6 is a block diagram that illustrates an image acquisition environment 600. Environment 600 includes a server 602 and mobile user device 604 communicatively coupled via a network 606.

Network 606 may include an electronic communications network, such as the Internet, a local area network (LAN), a wide area (WAN), a cellular communications network or the like. Network 606 may include a single network or combination of networks.

Mobile user device 604 may include any variety of mobile electronic devices. For example, mobile user device 604 may include a laptop, a tablet computer, a cellular phone, a personal digital assistant (PDA), or the like. In some embodiments, mobile user device 604 is a client of server 602. In some embodiments, mobile user device 604 includes various input/output (I/O) interfaces, such as a graphical user interface (e.g., a display screen), an image acquisition device (e.g., a camera 607), an audible output user interface (e.g., a speaker), an audible input user interface (e.g., a microphone), a keyboard, a pointer/selection device (e.g., a mouse, a trackball, a touchpad, a touchscreen, a stylus, etc.), a printer, or the like. In some embodiments, mobile user device 604 includes general computing components and/or embedded systems optimized with specific components for performing specific tasks. In some embodiments, mobile user device 604 includes applications (e.g., a panoramic image capture application) 608. Application 608 may include one or more modules having program instructions that are executable by a computer system to perform some or all of the functionality described herein with regard to mobile user device 604. For example, application 608 may include program instructions that are executable by a computer system to perform some or all of the steps of method 300. In some embodiments, mobile user device 604 includes a computer system similar to that of computer system 1000 described below with regard to at least FIG. 7.

Server 602 may include a network entity that serves requests by client entities. For example, server 602 may serve requests generated by mobile user device 604. In some embodiments, server 602 hosts a content site, such as a website, a file transfer protocol (FTP) site, an Internet search website or other source of network content. In some embodiments, server 602 includes an image acquisition server that serves instructions for acquiring images and/or generates updated panoramic images using images acquired/captured by users. In some embodiments, server 602 includes or otherwise has access to data store 610. Data store 610 may include a database or similar data repository. Data store 610 may include an image repository for storing images, including panoramic images associated with various locations.

In some embodiments, server 602 includes a panoramic image acquisition module 612. Module 612 may include program instructions that are executable by a computer system to perform some or all of the functionality described herein with regard to server 602. Module 612 may include program instructions that are executable by a computer system to perform some or all of the steps of method 300. In some embodiments, server 602 includes a computer system similar to that of computer system 1000 described below with regard to at least FIG. 7. Although server 602 is represented by a single box in FIG. 6, server 602 may include a single server (or similar system), or a plurality of servers (and/or similar systems). For example, server 602 may include a plurality of different servers (and/or similar systems) that are employed individually or in combination to perform some or all of the functionality described herein with regard to server 602.

In some embodiments environment 600 is used to employ techniques described herein (e.g., the steps of method 300). For example, when located at location 408, a user 614 may open a panoramic image acquisition application (e.g., application 608) on mobile user device 604 and submit a request to update a panoramic image 616 (e.g., as discussed with regard to block 302). Request 616 may be accompanied by location information 618 indicative of the current location of mobile user device 604. Panoramic image processing module 612 may process request 616 and identify a panoramic image location at or near the location of mobile user device 604 (e.g., as discussed with regard to block 304), and serve instructions 620 to guide user 614 to the identified panoramic image location and/or guide the user to capture a set of images 622 using camera 607 of mobile user device 604 (e.g., as discussed with regard to blocks 306 and 308). The set of images 622 may be provided to panoramic image processing module 612, and panoramic image processing module 612 may use the set of images 312 to generate an updated a panoramic image 624 (e.g., as discussed with regard to block 312). Updated panoramic image 624 may be stored in data store 610 in association with the panoramic image location (e.g., as discussed with regard to block 314). Upon receiving a subsequent request for a panoramic image view of a location at or near the panoramic image location (e.g., from a user device), the server 602 may retrieve updated panoramic image 624 from data store 610 and serve it for display (e.g., for display to a user via graphical user interface of the user device).

Exemplary Computer System

FIG. 7 is a block diagram that illustrates an exemplary computer system 1000. Various portions of systems and methods described herein, may include or be executed on one or more computer systems similar to system 1000. For example, server 602 and/or user device 604 may include a configuration similar to at least a portion of computer system 1000. Further, methods/processes/modules described herein (e.g., module 612 and/or application 608) may be executed by one or more processing systems similar to that of computer system 1000.

Computer system 1000 may include one or more processors (e.g., processors 1010a-1010n) coupled to system memory 1020, an input/output I/O device interface 1030 and a network interface 1040 via an input/output (I/O) interface 1050. A processor may include a single processor device and/or a plurality of processor devices (e.g., distributed processors). A processor may be any suitable processor capable of executing/performing instructions. A processor may include a central processing unit (CPU) that carries out program instructions to perform the basic arithmetical, logical, and input/output operations of computer system 1000. A processor may include code (e.g., processor firmware, a protocol stack, a database management system, an operating system, or a combination thereof) that creates an execution environment for program instructions. A processor may include a programmable processor. A processor may include general and/or special purpose microprocessors. A processor may receive instructions and data from a memory (e.g., system memory 1020). Computer system 1000 may be a uni-processor system including one processor (e.g., processor 1010a), or a multi-processor system including any number of suitable processors (e.g., 1010a-1010n). Multiple processors may be employed to provide for parallel and/or sequential execution of one or more portions of the techniques described herein. Processes and logic flows described herein may be performed by one or more programmable processors executing one or more computer programs to perform functions by operating on input data and generating corresponding output. Processes and logic flows described herein may be performed by, and apparatus can also be implemented as, special purpose logic circuitry, e.g., an FPGA (field programmable gate array) or an ASIC (application specific integrated circuit). Computer system 1000 may include a computer system employing a plurality of computer systems (e.g., distributed computer systems) to implement various processing functions.

I/O device interface 1030 may provide an interface for connection of one or more I/O devices 1060 to computer system 1000. I/O devices may include any device that provides for receiving input (e.g., from a user) and/or providing output (e.g., to a user). I/O devices 1060 may include, for example, graphical user interface displays (e.g., a cathode ray tube (CRT) or liquid crystal display (LCD) monitor), pointing devices (e.g., a computer mouse or trackball), keyboards, keypads, touchpads, scanning devices, voice recognition devices, gesture recognition devices, printers, audio speakers, microphones, cameras, or the like. I/O devices 1060 may be connected to computer system 1000 through a wired or wireless connection. I/O devices 1060 may be connected to computer system 1000 from a remote location. I/O devices 1060 located on remote computer system, for example, may be connected to computer system 1000 via a network and network interface 1040.

Network interface 1040 may include a network adapter that provides for connection of computer system 1000 to a network. Network interface may 1040 may facilitate data exchange between computer system 1000 and other devices connected to the network. Network interface 1040 may support wired or wireless communication. The network may include an electronic communication network, such as the Internet, a local area network (LAN), a wide area (WAN), a cellular communications network or the like.

System memory 1020 may be configured to store program instructions 1100 and/or data 1110. Program instructions 1100 may be executable by a processor (e.g., one or more of processors 1010a-1010n) to implement one or more embodiments of the present technique. Instructions 1100 may include modules of computer program instructions for implementing one or more techniques described herein with regard to various processing modules. Program instructions may include a computer program (also known as a program, software, software application, script, or code). A computer program may be written in any form of programming language, including compiled or interpreted languages, or declarative/procedural languages. A computer program may include a unit suitable for use in a computing environment, including as a stand-alone program, a module, a component, a subroutine. A computer program may or may not correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one or more computer processors located locally at one site or distributed across multiple remote sites and interconnected by a communication network.

System memory 1020 may include a tangible program carrier. A tangible program carrier may include a propagated signal and/or a non-transitory computer readable storage medium. A propagated signal may include an artificially generated signal (e.g., a machine generated electrical, optical, or electromagnetic signal) having encoded information embedded therein. The propagated signal may be transmitted by a suitable transmitter device to and/or received by a suitable receiver device. A non-transitory computer readable storage medium may include a machine readable storage device, a machine readable storage substrate, a memory device, or any combination thereof, or the like. Non-transitory computer readable storage medium may include, non-volatile memory (e.g., flash memory, ROM, PROM, EPROM, EEPROM memory), volatile memory (e.g., random access memory (RAM), static random access memory (SRAM), synchronous dynamic RAM (SDRAM)), bulk storage memory (e.g., CD-ROM and/or DVD-ROM, hard-drives), or the like. System memory 1020 may include a non-transitory computer readable storage medium having program instructions stored thereon that are executable by a computer processor (e.g., one or more of processors 1010a-1010n) to cause some or all of the subject matter and the functional operations described herein. A memory (e.g., system memory 1020) may include a single memory device and/or a plurality of memory devices (e.g., distributed memory devices).

I/O interface 1050 may be configured to coordinate I/O traffic between processors 1010a-1010n, system memory 1020, network interface 1040, I/O devices 1060 and/or other peripheral devices. I/O interface 1050 may perform protocol, timing or other data transformations to convert data signals from one component (e.g., system memory 1020) into a format suitable for use by another component (e.g., processors 1010a-1010n). I/O interface 1050 may include support for devices attached through various types of peripheral buses, such as a variant of the Peripheral Component Interconnect (PCI) bus standard or the Universal Serial Bus (USB) standard.

Embodiments of the techniques described herein may be implemented using a single instance of computer system 1000, or multiple computer systems 1000 configured to host different portions or instances of embodiments. Multiple computer systems 1000 may provide for parallel or sequential processing/execution of one or more portions of the techniques described herein.

Those skilled in the art will appreciate that computer system 1000 is merely illustrative and is not intended to limit the scope of the techniques described herein. Computer system 1000 may include any combination of devices and/or software that may perform or otherwise provide for the performance of the techniques described herein. For example, computer system 1000 may include a desktop computer, a laptop computer, a tablet computer, a server device, a client device, a mobile telephone, a personal digital assistant (PDA), a mobile audio or video player, a game console, a Global Positioning System (GPS), or the like. Computer system 1000 may also be connected to other devices that are not illustrated, or may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 1000 may be transmitted to computer system 1000 via transmission media or signals such as electrical, electromagnetic, or digital signals, conveyed via a communication medium such as a network and/or a wireless link. Various embodiments may further include receiving, sending or storing instructions and/or data implemented in accordance with the foregoing description upon a computer-accessible medium. Accordingly, the present invention may be practiced with other computer system configurations.

It should be understood that the description and the drawings are not intended to limit the invention to the particular form disclosed, but to the contrary, the intention is to cover all modifications, equivalents, and alternatives falling within the spirit and scope of the present invention as defined by the appended claims. Further modifications and alternative embodiments of various aspects of the invention will be apparent to those skilled in the art in view of this description. Accordingly, this description and the drawings are to be construed as illustrative only and are for the purpose of teaching those skilled in the art the general manner of carrying out the invention. It is to be understood that the forms of the invention shown and described herein are to be taken as examples of embodiments. Elements and materials may be substituted for those illustrated and described herein, parts and processes may be reversed or omitted, and certain features of the invention may be utilized independently, all as would be apparent to one skilled in the art after having the benefit of this description of the invention. Changes may be made in the elements described herein without departing from the spirit and scope of the invention as described in the following claims. Headings used herein are for organizational purposes only and are not meant to be used to limit the scope of the description.

As used throughout this application, the word “may” is used in a permissive sense (i.e., meaning having the potential to), rather than the mandatory sense (i.e., meaning must). The words “include”, “including”, and “includes” mean including, but not limited to. As used throughout this application, the singular forms “a”, “an” and “the” include plural referents unless the content clearly indicates otherwise. Thus, for example, reference to “an element” may include a combination of two or more elements. Unless specifically stated otherwise, as apparent from the discussion, it is appreciated that throughout this specification discussions utilizing terms such as “processing”, “computing”, “calculating”, “determining” or the like refer to actions or processes of a specific apparatus, such as a special purpose computer or a similar special purpose electronic processing/computing device. In the context of this specification, a special purpose computer or a similar special purpose electronic processing/computing device is capable of manipulating or transforming signals, typically represented as physical electronic or magnetic quantities within memories, registers, or other information storage devices, transmission devices, or display devices of the special purpose computer or similar special purpose electronic processing/computing device.

What is claimed is:

1. A computer-implemented method comprising:
receiving, from a mobile user device configured to acquire images, a request to update a panoramic image;
identifying a location associated with a panoramic image;
guiding a user to the location associated with the panoramic image;
receiving, from the mobile user device, an image acquired at or near the location associated with the panoramic image;
updating the panoramic image to include the image acquired at or near the location associated with the panoramic image to generate an updated panoramic image; and
storing the updated panoramic image in association with the location.

2. The method of claim 1, wherein guiding the user to the location associated with the panoramic image comprises providing, to the mobile user device for presentation to the user, instructions configured guide the user to the location associated with the panoramic image.

3. The method of claim 2, wherein the instructions comprise visual and/or audible instructions.

4. The method of claim 1, wherein guiding the user to the location associated with the panoramic image comprises:
receiving images acquired via a camera of the mobile user device; and
comparing the images acquired via a camera of the mobile user device to at least a portion of the panoramic image to determine whether the mobile device is positioned to acquire images for updating the panoramic image; and
in response to determining that the mobile device is not positioned to acquire images for updating the panoramic image, providing, to the mobile user device for presentation to the user, instructions configured guide the user to position the mobile device to acquire images for updating the panoramic image.

5. The method of claim 1, wherein guiding the user to the location associated with the panoramic image comprises:
determining a geographic location of the mobile user device;
comparing the geographic location of the mobile user device to the location associated with the panoramic image to determine whether the mobile device is located at or near the location associated with the panoramic image; and
in response to determining that the mobile device is not located at or near the location associated with the panoramic image, providing, to the mobile user device for presentation to the user, instructions configured guide the user to position the mobile device at or near the location associated with the panoramic image.

6. The method of claim 1, wherein identifying a location associated with a panoramic image comprises:
determining a geographic location of the mobile user device at or near the time of the request to update a panoramic image; and
identifying, from a plurality of locations associated with panoramic images, a location associated with a panoramic image that is nearest the geographic location of the mobile user device.

7. The method of claim 1, wherein identifying a location associated with a panoramic image comprises:
determining a geographic location of the mobile user device at or near the time of the request to update a panoramic image;
presenting the user with a plurality of locations associated with a panoramic images that are proximate the geographic location of the mobile user device at or near the time of the request to update a panoramic image; and
receiving user selection of one of the plurality of locations associated with a panoramic images.

8. The method of claim 1, wherein updating the panoramic image to include the image acquired at or near the location to generate an updated panoramic image comprises:
generating a full panoramic view using the image; and
replacing the panoramic image with the full panoramic view to generate an updated panoramic image.

9. The method of claim 1, wherein updating the panoramic image to include the image acquired at or near the location to generate an updated panoramic image comprises replacing a corresponding portion of the panoramic image with the image to generate an updated panoramic image.

10. A system comprising:
one or more memories storing instructions; and
one or more processors coupled to the one or more memories and configured to execute the instructions stored thereon to cause the following steps:
receiving, from a mobile user device configured to acquire images, a request to update a panoramic image;
identifying a location associated with a panoramic image;
guiding a user to the location associated with the panoramic image;
receiving, from the mobile user device, an image acquired at or near the location associated with the panoramic image;
updating the panoramic image to include the image acquired at or near the location associated with the panoramic image to generate an updated panoramic image; and
storing the updated panoramic image in association with the location.

11. The system of claim 10, wherein guiding the user to the location associated with the panoramic image comprises providing, to the mobile user device for presentation to the user, instructions configured guide the user to the location associated with the panoramic image.

12. The system of claim 11, wherein the instructions comprise visual and/or audible instructions.

13. The system of claim 10, wherein guiding the user to the location associated with the panoramic image comprises:
receiving images acquired via a camera of the mobile user device; and
comparing the images acquired via a camera of the mobile user device to at least a portion of the panoramic image to determine whether the mobile device is positioned to acquire images for updating the panoramic image; and
in response to determining that the mobile device is not positioned to acquire images for updating the panoramic image, providing, to the mobile user device for presentation to the user, instructions configured guide the user to position the mobile device to acquire images for updating the panoramic image.

14. The system of claim 10, wherein guiding the user to the location associated with the panoramic image comprises:
determining a geographic location of the mobile user device;
comparing the geographic location of the mobile user device to the location associated with the panoramic image to determine whether the mobile device is located at or near the location associated with the panoramic image; and
in response to determining that the mobile device is not located at or near the location associated with the panoramic image, providing, to the mobile user device for presentation to the user, instructions configured guide the user to position the mobile device at or near the location associated with the panoramic image.

15. The system of claim 10, wherein identifying a location associated with a panoramic image comprises:
determining a geographic location of the mobile user device at or near the time of the request to update a panoramic image; and
identifying, from a plurality of locations associated with panoramic images, a location associated with a panoramic image that is nearest the geographic location of the mobile user device.

16. The system of claim 10, wherein identifying a location associated with a panoramic image comprises:
determining a geographic location of the mobile user device at or near the time of the request to update a panoramic image;
presenting the user with a plurality of locations associated with a panoramic images that are proximate the geographic location of the mobile user device at or near the time of the request to update a panoramic image; and
receiving user selection of one of the plurality of locations associated with a panoramic images.

17. The system of claim 10, wherein updating the panoramic image to include the image acquired at or near the location to generate an updated panoramic image comprises:
generating a full panoramic view using the image; and
replacing the panoramic image with the full panoramic view to generate an updated panoramic image.

18. The system of claim 10, wherein updating the panoramic image to include the image acquired at or near the location to generate an updated panoramic image comprises replacing a corresponding portion of the panoramic image with the image to generate an updated panoramic image.

19. A non-transitory computer readable medium comprising program instructions stored thereon that are executable by a processor to cause the following steps:
receiving, from a mobile user device configured to acquire images, a request to update a panoramic image;
identifying a location associated with a panoramic image;
guiding a user to the location associated with the panoramic image;
receiving, from the mobile user device, an image acquired at or near the location associated with the panoramic image; and
updating the panoramic image to include the image acquired at or near the location associated with the panoramic image to generate an updated panoramic image;
storing the updated panoramic image in association with the location.

20. The medium of claim 19, wherein guiding the user to the location associated with the panoramic image comprises providing, to the mobile user device for presentation to the user, instructions configured guide the user to the location associated with the panoramic image.

21. The medium of claim 20, wherein the instructions comprise visual and/or audible instructions.

22. The medium of claim 19, wherein guiding the user to the location associated with the panoramic image comprises:
receiving images acquired via a camera of the mobile user device; and
comparing the images acquired via a camera of the mobile user device to at least a portion of the panoramic image to determine whether the mobile device is positioned to acquire images for updating the panoramic image; and
in response to determining that the mobile device is not positioned to acquire images for updating the panoramic image, providing, to the mobile user device for presentation to the user, instructions configured guide the user to position the mobile device to acquire images for updating the panoramic image.

23. The medium of claim 19, wherein guiding the user to the location associated with the panoramic image comprises:
determining a geographic location of the mobile user device;
comparing the geographic location of the mobile user device to the location associated with the panoramic image to determine whether the mobile device is located at or near the location associated with the panoramic image; and
in response to determining that the mobile device is not located at or near the location associated with the panoramic image, providing, to the mobile user device for presentation to the user, instructions configured guide the user to position the mobile device at or near the location associated with the panoramic image.

24. The medium of claim 19, wherein identifying a location associated with a panoramic image comprises:
determining a geographic location of the mobile user device at or near the time of the request to update a panoramic image; and
identifying, from a plurality of locations associated with panoramic images, a location associated with a panoramic image that is nearest the geographic location of the mobile user device.

25. The medium of claim 19, wherein identifying a location associated with a panoramic image comprises:
determining a geographic location of the mobile user device at or near the time of the request to update a panoramic image;
presenting the user with a plurality of locations associated with a panoramic images that are proximate the geographic location of the mobile user device at or near the time of the request to update a panoramic image; and
receiving user selection of one of the plurality of locations associated with a panoramic images.

26. The medium of claim 19, wherein updating the panoramic image to include the image acquired at or near the location to generate an updated panoramic image comprises:
generating a full panoramic view using the image; and
replacing the panoramic image with the full panoramic view to generate an updated panoramic image.

27. The medium of claim 19, wherein updating the panoramic image to include the image acquired at or near the location to generate an updated panoramic image comprises replacing a corresponding portion of the panoramic image with the image to generate an updated panoramic image.
